(19) United States
(12) Patent Application Publication
(10) Pub. No.: US 2004/0124965 A1
(43) Pub. Date: Jul. 1, 2004

(54) Optical door lock safety recognition system

(76) Inventor: Jin-Chern Chiou, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/328,035

(22) Filed: Dec. 26, 2002

(51) Int. Cl. G05B 19/00; H04Q 1/00

(52) U.S. Cl. 340/5.6; 340/5.7

(57) ABSTRACT

The present invention provides an optical door lock safety recognition system, which is positioned a bar code pattern on a surface of a key and to match with a door lock apparatus for practicing. There is an electromagnetic valve arranged within the door lock apparatus to curb a bayonet for limiting the movement of the lock head. There is a photography module is positioned at an outside of the notch channel and comprises a light emitting element and a photo sensor element so as to utilize the infrared rays to scan a bar code pattern of the key to form an output of a corresponding analog signal. A signal switch circuit is to transfer the analog signal into a plus signal to a microprocessor. The microprocessor is to transfer the plus into an output of a decoded signal to a control end so as to perform a comparison and a storage of the decoded signal and to transmit a order to the microprocessor in accordance with a comparison result and to decide if a conductive signal is transmitted to the electromagnetic valve in accordance with the order to lift the curbing of the bayonet. Hence, the present invention provides with advantages of low cost, assembling easily, and easy operation for users.

### BACKGROUND OF THE INVENTION

1. Field of the Invention

The present invention generally relates to a door lock, and more particularly relates to a door lock system, which is provided with the function of the encryption and the optical decryption.

2. Description of the Prior Art

In daily life, the door is not merely related to the adornment of the living room, but also related to some important matters, such as the leisure safety and personal private. Hence, the lock is a critical feature of a door; the door will lose its major function for anti-intruding the private space if without a good lock. In generally speaking, the quality of the key is depended on the purpose of a room. For example, a front door lock should be considered about the safety of the whole house, so it should choose a rigid burglarproof lock; a bedroom does not need too high quality for burglarproof and only need the personal private.

With the development of the society, it is easy for the lawless persons to open a normal door lock, and the key is easily copied so as the safety of the door lock of the conventional family subject to be challenged again and again. Hence, it is a certainly trend for constructing a new safety mechanism of the door lock. Furthermore, once the lawless person is to open the door lock, there are not only losing the asset, but also damaging the house. It would cost a lot of time, money, and mind to make up for the loss of the commemorative value or lovely things stolen or damaged by the burglar.

Conventional door lock is utilizing the notch of the key and the bayonet projection portion of the keyhole to compare, if the sunken portion of the notch is matching with the bayonet projection portion, the bayonet is to be open to drive the lock head. However, the design as mentioned above is easy to be solved by the burglar. Obviously, the main spirit of the present invention is to provide a door lock safety recognition system, which is to encrypt on the key and to match another bayonet to lock the whole lock head. After the decrypting step, the notch of the key can further be compared with the keyhole. Then, some disadvantages of well-known technology are overcome.

### SUMMARY OF THE INVENTION

The primary object of the present invention is to provide an optical door lock safety recognition system, which can utilize to encrypt on the key and to match a bayonet of a control lock head of an electromagnetic valve so as the key can be opened after the optical scanning and decrypting to achieve the effect of double burglarproof.

Another object of the present invention is to provide an optical door lock safety recognition system, which is low cost, assembling easily, and easy operation for users.

A further object of the present invention is to provide optical door lock safety recognition system, which utilizes different codes presenting the different identification of accessing persons so as to automatically percolate and control the identification of the accessing person and the accessing time via the control of the control end and the set up of the entrance guard level to immediately control the status of the entrance guard.

A furthermore object of the present invention is to provide an optical door lock safety recognition system, which can build the database of the user to display and track the user data so as to provide an administrative system with more certainly and more safety.

In order to achieve previous objects, the optical door lock safety recognition system of the present invention includes a key and a door lock apparatus, wherein there are positioned a plurality of notches and a bar code pattern on a surface of the key, and there arc a lock head, a first bayonet for limiting the movement of the lock head, and a notch channel for providing the insertion of the key positioned in the door lock apparatus. Besides, the electromagnetic valve arranged a second bayonet for limiting the movement of the first bayonet is utilizing for limiting the movement of the first bayonet. A photography module is positioned within the door lock apparatus and at an outside of the notch channel, wherein the photography module comprises a light emitting element and a photo sensor element so as to emit the light to a bar code pattern of the key via the light emitting element and then to reflect a corresponding patterned light, and wherein the photo sensor element is forming an output of a corresponding analog signal in accordance with the patterned light. A signal switch circuit is positioned within the door lock apparatus and connected with the photo sensor element, wherein the signal switch circuit is used for transferring the analog signal into a plus signal to a microprocessor. The microprocessor is receiving the plus signal and to transfer into an output of a decoded signal and to control about connecting or not connecting of the electromagnetic valve. Besides, a control end is connected to the microprocessor so as to perform a comparison step and a storage step of the decoded signal, and to transmit an order to the microprocessor in accordance with a comparison result and to decide if a conductive signal is transmitted to the electromagnetic valve in accordance with the order.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the architecture of the block diagram, in accordance with the present invention;

FIG. 2 is a schematic representation of the partial architecture, in accordance with the present invention;

FIG. 3 is a schematic representation of the structure of the photography module, in accordance with the present invention;

FIG. 4 is a schematic representation of the interior structure of the signal switch circuit, in accordance with the present invention;

FIG. 5 is a schematic representation of the control end, in accordance with a preferred embodiment of the present invention;

FIG. 6 is a schematic representation of the bar code pattern on the key, in accordance with the present invention; and

FIG. 7 is a schematic representation of the operation flowchart, in accordance with the present invention.

### DESCRIPTION OF THE PREFERRED EMBODIMENT

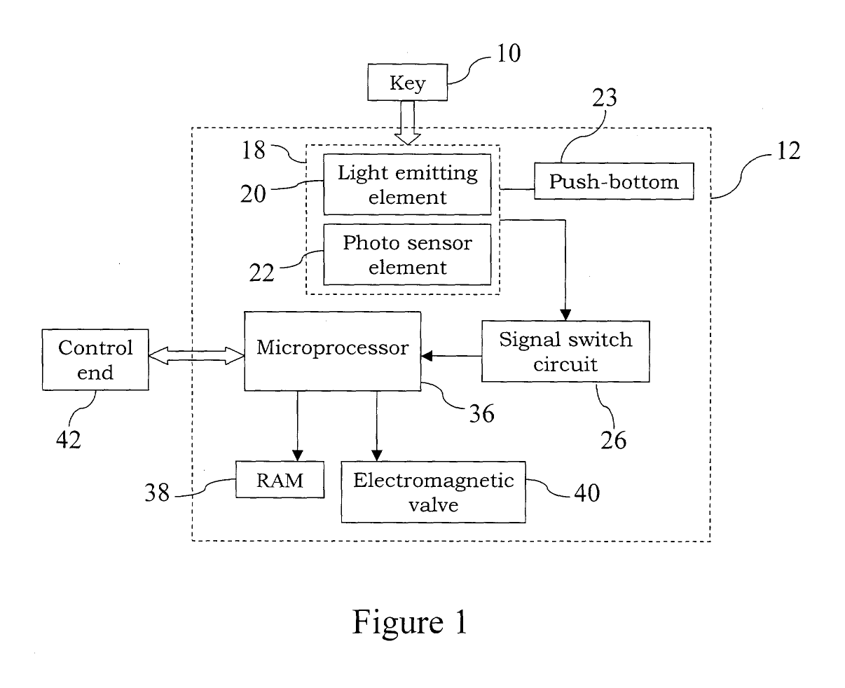

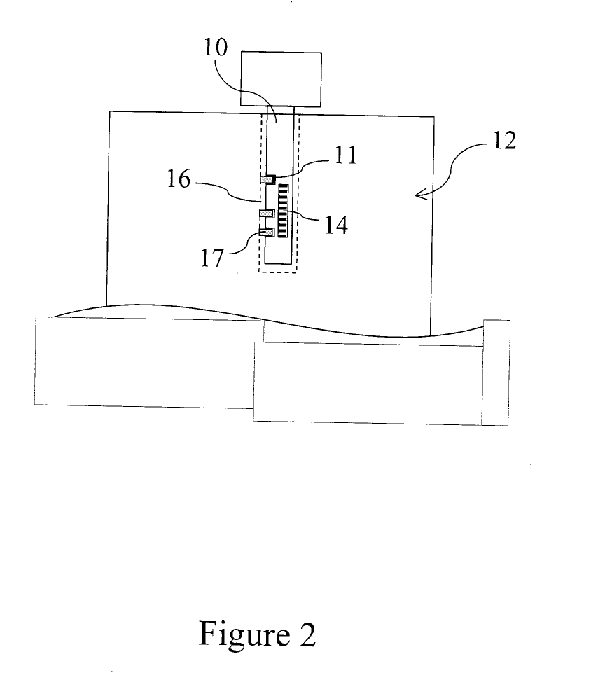

The schematic representation of the architecture of the present invention is shown in the FIG. 1 and FIG. 2, an optical door lock safety recognition includes a key 10 and a door lock apparatus 12, wherein there are positioned a plurality of notches 11 and fillisters (not shown in the drawing) on a surface of the key 10. There is a bar code pattern 14, which is a plastic bar code, stacked within one fillister and the bar code pattern 14 is stacking a protection film thereon. The code type of the bar code pattern 14 will be detailed described as the following. A notch channel 16 providing the insertion of the key 10 is positioned in a door lock apparatus 12, wherein the inside wall of the notch channel 16 is arranged a plurality of bayonet projection portions 17 which are corresponding to those notches 11 of the surface of the key 10. The area lock head (not shown in the drawing) positioned in the door lock apparatus 12 and a first bayonet (not shown in the drawing) for limiting the movement of the lock head. There is further an electromagnetic valve 40 for limiting the movement of the first bayonet by utilizing a second bayonet (not shown in the drawing), which is usually an iron stick, within the electromagnetic valve 40. When the electromagnetic valve 40 is not conductive, the iron stick will be bulge out to the electromagnetic valve 40 to limit the movement of the first bayonet; when the electromagnetic valve 40 is conductive, the iron stick will be retracted in to release the limitation of the movement of the first bayonet.

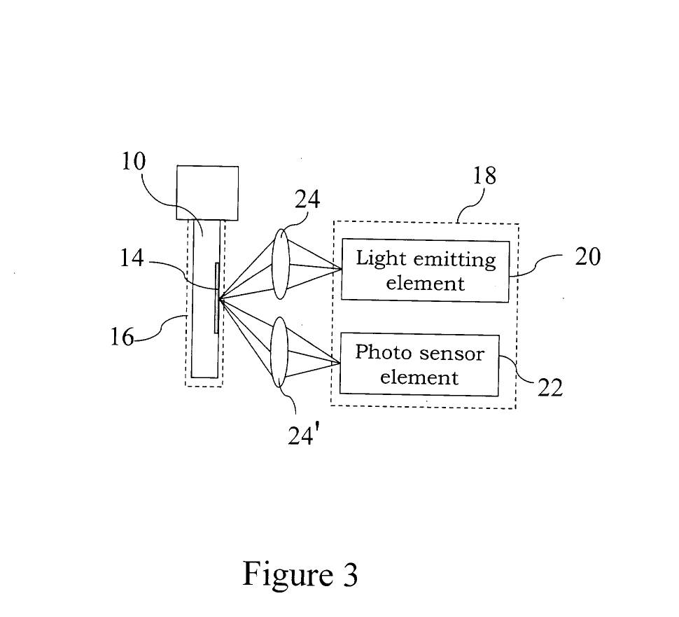

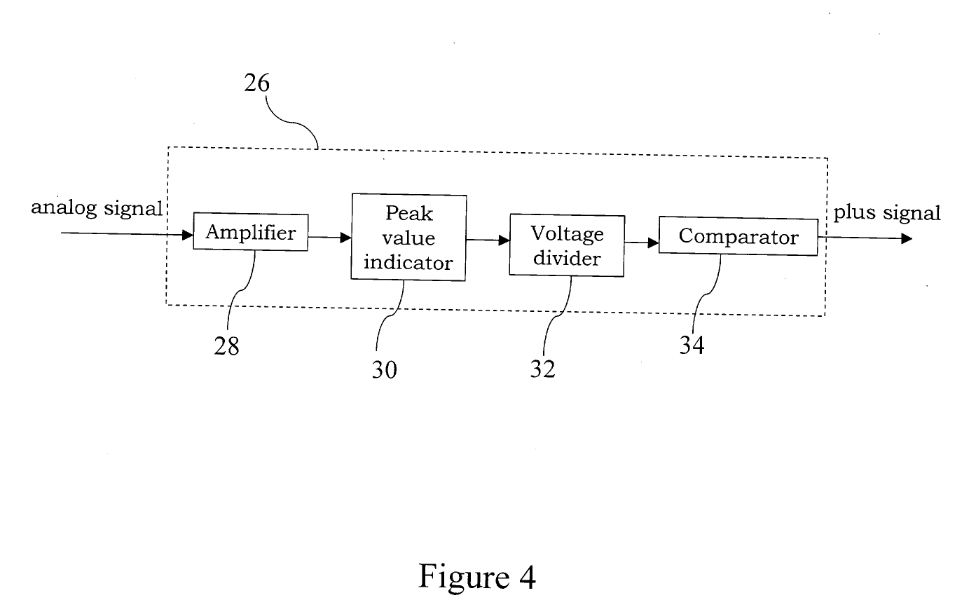

Simultaneously referring to the FIG. 3, the outside of the notch channel 16 is arranged a photography module 18, which comprises a light emitting 20 and a photo sensor element 22. Wherein the light emitting element 20 is usually an infrared rays light emitting diodes and utilizing a push-bottom 23 to switch on to emit the light source of the infrared rays. The photo sensor element 22 is usually a photosensitive resistance, a photo emitting diodes, or a phototransistor. Focusing lens 24 and 24′ are respectively positioned between the light emitting element 20 and the notch channel 16 and between the notch channel 16 and the photo sensor element 22 so as to utilize the light emitting element 20 to emit the light source of the infrared rays and to focusing the light source via the focusing lens 24 into the bar code pattern 14 of the key 10. Then, a patterned light corresponding to the bar code pattern 14 will be focused via the focusing lens 24′ to emit into the photo sensor element 22 so as the photo sensor element 22 will form a corresponding output of the analog signal in accordance the received patterned light. Referring to the FIG. 1, the photo sensor element 22 is connected with a signal switch circuit 26, wherein the detailed circuitry thereof is as shown in the FIG. 4. The signal switch circuit 26 comprises a amplifier 28 for receiving the analog signal amplifying the waveform thereof; a peak value indicator 30 for detecting the amplified waveform of a wave crest value and a wave trough value; a voltage divider 32, is composed of two inphase resistances, connected with the peak value indicator 30 for finding a position point of fifty percent of said amplified waveform in accordance with the wave crest value and the wave trough value; and a comparator 34 is utilized to transfer a signal at the position point of fifty percent of the amplified waveform into an output of the plus signal, wherein the comparator can utilizes a operation amplifier to do that.

The comparator 334 of the signal switch circuit 26 mentioned above is further connected to a microprocessor 36 so as to utilize the microprocessor 36 to receive the plus signal and to calculate the time width, and then to transfer the plus signal into an output of a decoded signal. The microprocessor 36 is connecting with a random access memory (RAM) 38 for using as a temporary data storage region of the action process of the microprocessor 36. The microprocessor 36 is further connecting to the electromagnetic valve 40 to utilize the microprocessor 36 to control if the electromagnetic valve is conductive.

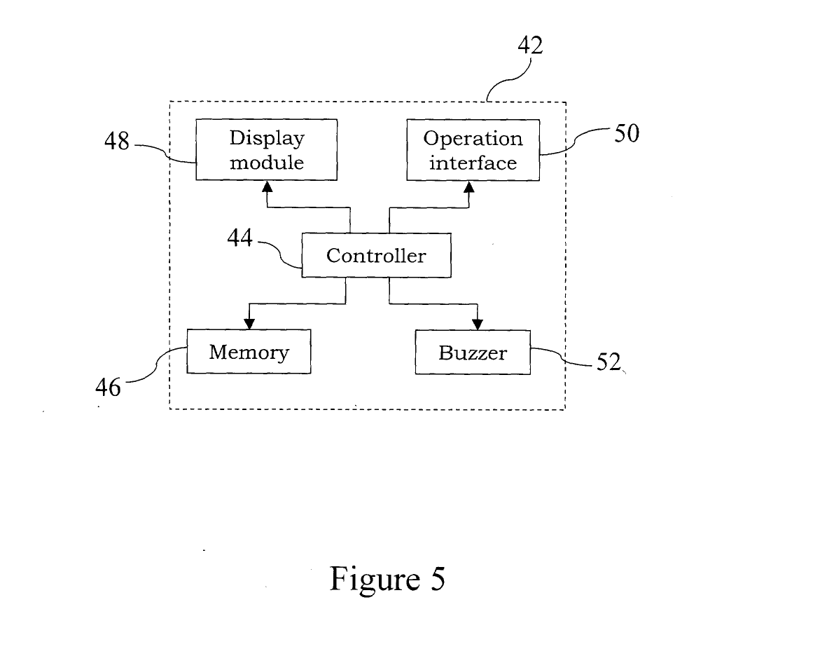

There is further a control end 42 via the RS232 interface to connect to the microprocessor 36 to perform the comparison of the decoded signal from the microprocessor 36 and the built-in data, perform the storage step, and to transmit an order to the microprocessor 36 in accordance with the comparison result. The microprocessor 36 would decide if a conductive signal is transmitted to the electromagnetic valve 40 to drive it to make it conductive in accordance with the received order. Referring to the FIG. 5, in one embodiment of the present invention, the control end 42 is a computer apparatus including a controller 44, a memory 46, a display module 48, an operation interface 50, and a buzzer 52. The controller 44 is utilized to control the action of each element within the control end and to communicate the surrounding. The memory 46 is provided to store the comparison data and the display module 48 is used to display the user data and the using status. The operation interface 50 provides the function of easily set up and operation. The buzzer 52 provides the warning function. The control end 42 can be further connected to the Internet for users easily control the status of the entrance guard from the far-end.

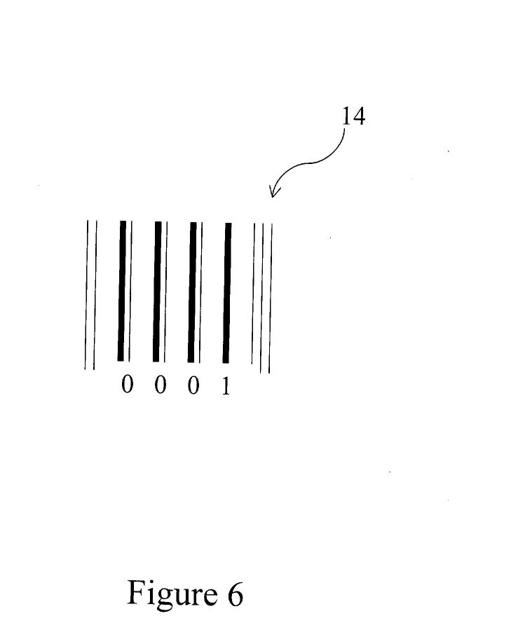

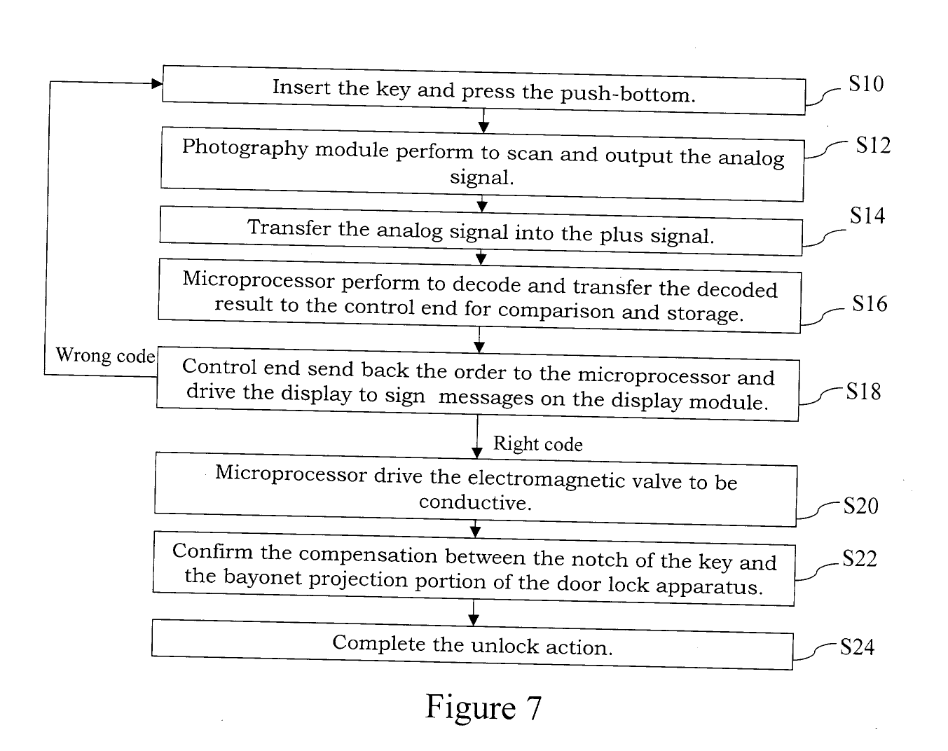

Referring to the FIG. 6, the bar code pattern 14 of the key 10 of the present invention is usually using an EAN bar code, which is composed of black, white, broad, and narrow lines to present to different characters, such as the black line is presented the logic 1, the white line is presented the logic 0, and the different width between each code region can further compose different logic types. When the user wants to unlock the door, the operation procedure is as shown in the FIG. 7 and matching with the structure mentioned above. First, as shown in the step S10, the user inserts the key 10 into the notch channel 16of the door lock apparatus 12. Then, the photography module 18 will produce the action by pressing the push-bottom of the door lock apparatus 12 so as the light emitting element 20 to emit the infrared rays light. Then, as shown in the step S12, the light emitted from the light emitting element 20 is been focused to emit to the bar code pattern 14 of the key 10. After illuminating the black line and the white line of the bar code pattern 14 via the light emitting element 20, the reflected patterned light will cause different respond of the photo sensor element 22 to change its detecting voltage or current so as the photo sensor element 22 will output an analog signal corresponding to the patterned light. Following, as shown in the step S14, the signal switch circuit 26 is receiving the analog signal and transfer the analog signal into an output of a plus signal. Last, as shown in the step S 16, the microprocessor 36 is receiving the plus signal and to decode the plus signal, and then transmit the decoded signal into the control end 42 to perform the comparison and the storage.

Following, as shown in the step S18, when the control end 42 is receiving the decoded signal, the control end 42 will start to perform the comparison and the recognition of the user name. After the comparison, if the user is not recognized, the present invention will repeat the step S10 and the control end 42 will transmit a sign in message of an un-admitted signal and to make the warning sound from the buzzer 50. If the user is recognized, the present invention is going to the step S20. At this time, the control end 42 transmits an action order to the microprocessor 36 and the microprocessor 36 will transmits a conductive signal into the electromagnetic valve in accordance with the action order to drive the electromagnetic valve to be conductive to retract the iron stick for limiting the movement of the bayonet of the lock head. Following, as shown in the step S22, the user can further rotate the key 10 to open the bayonet of the lock head of the door lock apparatus 12. Then, the lock head is retracted to complete the action of unlocking the lock, such as shown in the step S24.

After-finishing the action mentioned above, the controller 44 within the control end 42 will transmit a sign in signal to the display module 48 to display the sign in message, which is including the user identification, name, and the sign in status for the management inquiring. The management can utilize the displayed message on the display module 48 to immediately know the status of locking or unlocking of the door lock apparatus 12, wherein the status is including the person entranced before, if someone without the recognized level tries to unlock the door, and the storage data of the sign in message for tracking or searching afterward.

Besides, in order to prevent the suddenly break down of the power supply to cause the situation that the optical door lock safety recognition system could not deal to dead lock the door lock apparatus, the present invention can further utilize a power supply apparatus to provide the electric power.

Under the consideration of the operation method and the cost, the present invention is arranged an electromagnetic valve in a conventional door lock to utilize the electromagnetic valve for limiting the movement of the lock head. The present invention matches the use of encrypting on the key so as to utilize the infrared rays photography module to scan and to output an analog signal. Then, the present invention utilizes the decoding of a microprocessor and the comparison of the control end to recognize if the user has the use of the limits of authority. Hence, the optical door lock safety recognition system of the present invention is low cost, assembling easily, and easy operation for users. Furthermore, the electromagnetic valve can be driven and connected to further drive the key to open the lock after the optical decryption, so the present invention can achieve the effect of double burglarproof. Hence, the present invention can overcome the disadvantage of the illicit opening of the prior door lock apparatus and utilize different codes presenting the different identification of accessing persons so as to automatically percolate and control the identification of the accessing person and the accessing time via the control of the control end and the set up of the entrance guard level to immediately control the status of the entrance guard. Besides, the optical door lock safety recognition system of the present invention can build the database of the user to display and track the user data so as to provide an administrative system with more certainly and more safety.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A optical door lock safety recognition system including:
a key, wherein a surface of said key is positioned a plurality of notches and a bar code pattern;
a door lock apparatus, wherein said door lock apparatus is positioned a lock head, a first bayonet for limiting the movement of said lock head, and a notch channel for providing the insertion of said key;
an electromagnetic valve positioned in said door lock apparatus, wherein said electromagnetic valve is arranged a second bayonet for limiting the movement of said first bayonet;
a photography module positioned within said door lock apparatus and at an outside of said notch channel, wherein said photography module comprises a light emitting element and a photo sensor element so as to emit the light to a bar code pattern of said key via said light emitting element and then to reflect a corresponding patterned light, and wherein said photo sensor element is forming an output of a corresponding analog signal in accordance with said patterned light;
a signal switch circuit positioned within said door lock apparatus and connected with said photo sensor element, wherein said signal switch circuit is used for transferring said analog signal into a plus signal;
a microprocessor positioned with said door lock apparatus so as to receive said plus signal and to transfer into an output of a decoded signal; and
a control end connecting to said microprocessor so as to perform a comparison and a storage of said decoded signal and to transmit a order to said microprocessor in accordance with a comparison result and to decide if a conductive signal is transmitted to said electromagnetic valve in accordance with said order.

2. The optical door lock safety recognition system according to claim 1, wherein said light emitting element is an infrared rays light emitting diodes.

3. The optical door lock safety recognition system according to claim 1, wherein said photo sensor element is selected from the group of photosensitive resistant, photo emitting diodes, and photo-transistor.

4. The optical door lock safety recognition system according to claim 1, further comprises a focusing lens positioned between said light emitting element and said notch channel for providing the insertion of said key.

5. The optical door lock safety recognition system according to claim 1, wherein further comprises a focusing lens positioned between said photo sensor element and said notch channel for providing the insertion of said key.

6. The optical door lock safety recognition system according to claim 1, wherein said signal switch circuit comprises the following elements:
an amplifier for amplifying a waveform of said analog signal;
a peak value indicator for detecting said amplified waveform of a wave crest value and a wave trough value;
a voltage divider for finding a position point of fifty percent of said amplified waveform; and
a comparator for transferring a signal at said position point of fifty percent of said amplified waveform into said plus signal.

7. The optical door lock safety recognition system according to claim 6, wherein said voltage divider is composed of two inphase resistances.

8. The optical door lock safety recognition system according to claim 6, wherein said comparator is an operation amplifier.

9. The optical door lock safety recognition system according to claim 1, wherein said microprocessor is further connecting a memory.

10. The optical door lock safety recognition system according to claim 1, wherein said control end is a computer apparatus.

11. The optical door lock safety recognition system according to claim 1, wherein said microprocessor is using a RS232 interface to connect with said control end.

12. The optical door lock safety recognition system according to claim 1, wherein said door lock apparatus is arranged a push-bottom for switching said light emitting element to emit light.

13. The optical door lock safety recognition system according to claim 1, wherein said bar code pattern is an EAN bar code.

14. The optical door lock safety recognition system according to claim 1, wherein said control end is including a controller, a display module, and an operation interface.

15. The optical door lock safety recognition system according to claim 1, wherein said control end further provides to connect to the Internet.

16. The optical door lock safety recognition system according to claim 1, wherein said control end further comprises a buzzer.

17. The optical door lock safety recognition system according to claim 1, wherein said door lock apparatus is further connecting a power supply apparatus.

18. The optical door lock safety recognition system according to claim 1, wherein said bar code pattern is a plastic bar code and positioned within a fillister of said key.

19. The optical door lock safety recognition system according to claim 1, further comprises a protection film positioned on a surface of said bar code pattern.
